(19) United States
(12) Patent Application Publication
(10) Pub. No.: US 2008/0147659 A1
(43) Pub. Date: Jun. 19, 2008

(54) System and method for determining behavioral similarity between users and user data to identify groups to share user impressions of ratable objects

(75) Inventors: Kefeng Chen, Duluth, GA (US); Christopher T.M. Bailey, Atlanta, GA (US); Michael J. Rowan, Wakefield, MA (US); Neal Lewis Creighton, Wellesley Hills, MA (US)

Correspondence Address: WILMERHALE/BOSTON, 60 STATE STREET, BOSTON, MA, 02109, US

(73) Assignee: RatePoint, Inc.

(21) Appl. No.: 11/639,678

(22) Filed: Dec. 15, 2006

(51) Int. Cl. G06F 7/08; G06F 17/30

(52) U.S. Cl. 707/7; 707/5

(57) ABSTRACT

A system and method for determining behavioral similarity between users and user data to identify groups to share user impressions of ratable objects. A computerized rating system identifies a plurality of users of the network. The usage activities of users within the network is automatically monitored and compiled. By analyzing the compiled information, similarity among users is determined, and used to define a social group. An aggregate rating for each ratable computerized entity as a function of rating information received from each member of a social group is determined from recorded rating information. The computerized rating system presents on a display the aggregate rating information for a ratable computerized entity for a social group to a user who is a member of the social group.

### CROSS REFERENCE TO RELATED APPLICATIONS

This application is related to the following co-pending U.S. patent application Ser. No. TBA, filed on an even date herewith, entitled SYSTEM AND METHOD FOR PARTICIPATION IN A CROSS PLATFORM AND CROSS COMPUTERIZED-ECO-SYSTEM RATING SERVICE, the contents of which is incorporated herein in its entirety by reference.

### BACKGROUND

1. Technical Field of the Invention

The present invention relates generally to electronic services that allow users to rate services and the like and to receive rating information about such services and the like and, more particularly, to a system and method for automatically defining a group of users, for example, from their behavioral similarity, and employing user data to determine an aggregate rating for the automatically defined group.

2. Discussion of Related Art

The Internet and the World-Wide-Web are increasingly becoming a major source of information for many people. New information (good or bad) appears on the Internet constantly. In order to help people better determine the usefulness of this information, rating services exist to provide both rating and commenting information that may help people make better determinations about the usefulness about sites and/or services, brick and mortar companies, products, services, Internet sites, web pages and/or specific content within a web page.

The majority of these systems solicit the user's rating and opinions on a specific entity, such as a company, a product, a web site, an article or a web page. When a user is looking for rating information regarding an entity, either for online shopping or any other purpose, the system presents an average mean rating for the entity to the user. The average mean rating is normally calculated as adding all the ratings and dividing the sum by the number of people that rated the entity. This is known as the generic arithmetic mean (average). This information is usually provided to users to show what other users have rated an entity and what the generic arithmetic mean is for an entity. This information is usually provided to users with some visual cue to represent the rating. Sometimes the system also tells the user how many people have rated this entity. When these systems present a rating to a user, there is no consideration of the persons who rate the entity, what the person's background is who rated the entity, or how knowledgeable the person is regarding to the entity. Since peoples' opinion on an entity can vary widely based on their various experiences and background, the generic arithmetic mean (average) for a particular entity could carry much less meaning for a focused user looking for a like-minded opinion regarding to a particular entity.

Some systems use some kind of group concept and present users with a more refined group ratings or opinions. For example, TrustedOpinion presents ratings and recommendations from a user's friend circle. The assumption is that friends' opinions are more meaningful and reliable than those of a stranger. The system needs a member to define a trusted friend and manually keep the friends in his friend circle. Other system such as StumbleUpon uses a user's registered interest categories to link different users with common interests. The recommendations from users share the common interest categories will get high marks. It uses this method to help people surf the Internet. Some other systems use a trusted chain model to define a refined circle. For example, a user of Lijit system gets high ratings from his trusted friends. The relationship is defined by a user himself through searching the system for a popular user in the system, a known user or users with a common interest.

### SUMMARY

The present invention provides a system and method for determining behavioral similarity between users and user data to identify groups to share user impressions of ratable objects.

Under one aspect of the invention, computerized rating system identifies a plurality of users of the network. The computerized rating system automatically monitors usage activities of the plurality of users to compile and record information about the usage of ratable computerized entities within the network by each user. By analyzing the compiled information the system determines similarity among users and to define social groups of users in which each member of a social group has a similar usage analysis profile of ratable computerized entities to other members of the group. The system receives and records rating information from the users about the computerized ratable entities and for each social group, determines an aggregate rating for each ratable computerize entity as a function of the rating information received from each member of each group. The computerized rating system presents on a display the aggregate rating information for a ratable computerized entity for a social group to a user who is a member of the social group.

Under another aspect of the invention, the similarity among users is determined by a distance function.

Under another aspect of the invention, analyzing the compiled information to determine similarity among users is further determined by the usage analysis profile of the user.

Under another aspect of the invention, analyzing the compiled information to determine similarity among users is further determined by the rating provided by the user of the ratable computerized entity.

Under other aspects of the invention, the usage analysis profile of the user includes web-visiting records, tagging records, rating records and using a fully qualified domain name.

Under another aspect of the invention, automatically monitoring usage activities of the plurality of users further includes using a server system web portal.

### BRIEF DESCRIPTION OF THE DRAWINGS

In the drawings:

FIG. 1 shows a block diagram of a user rating system with the basic infrastructure needed to provide a service;

FIG. 2 shows a screen display of a web portal 1001 home page for an exemplary system;

FIG. 3 shows a screen display of a user registration input fields;

FIG. 4 shows the process flow when a user uses an exemplary system to get rating information on an URI;

FIG. 5 shows how a system provides a user with a generic arithmetic rating or a generic arithmetic rating and a social circle mean rating;

FIG. 6 shows the process flow of a system to calculate a social circle based on a user's rating records;

FIG. 7 shows the process flow of a system to calculate a social circle based on a user's web URI visiting records;

FIG. 8 shows the process flow of a system to calculate a social circle based on a user's web category visiting records;

FIG. 9 shows the process flow to use URI unit to cover a fully qualified domain name for calculating a social circle;

FIG. 10 shows the process flow of a system to calculate a social circle based on a user's tagging records;

FIG. 11 shows the process flow of a system to calculate a user's social circle using a user's rating records, tagging records, URI visiting records and web category visiting records;

FIG. 12 shows an example of the infrastructure needed to allow participants to collaborate rating information about resources; and

FIG. 13 shows an example of an application use a social circle to present various information.

### DETAILED DESCRIPTION

Preferred embodiments of the invention provide a mechanism to automatically identify a group of like-minded users so that rating information may be compiled from and shared with such a group. Under certain embodiments of the invention, user activity is monitored and analyzed via a similarity function to identify like-minded users to identify such a group. The group is referred to as a social circle though there is no mandatory requirement that a user actually know the other users of a social circle group or to socialize with such. When a user is looking for a rating on an entity, like a company, a product, a URI, a web site, a web page content, a virtual object, virtual products, or virtual service, the system presents the user a generic average mean rating on the entity determined from all ratings from users. The system also presents the user with a much more refined mean rating which is determined from users who belong to the user's social circle. A user's social circle changes with user's online activities. A user's social circle is determined dynamically whenever a user behavior changes.

The system and method for determining behavioral similarity between users and user data to identify groups to share user impressions of ratable objects is described here. In preferred embodiments, it entails a system that provides user ratings on URIs in both generic arithmetic mean rating format and a social circle mean rating format. Both such formats are discussed more fully in the sections that follow. The system can be applied to an entity as a company, a product, a URI, a web site, web page content, a virtual object, virtual products, or virtual services. In the exemplary system, URI ratings are used.

Under preferred embodiments of the invention, a user can obtain a particular rating on an entity through an application or an element and/or entity within or accessible via a URI and/or application either through an Internet capable application like a web browser (via a toolbar, web page or web portal), Javascript, Flash object, application programming interface (API) or any other method that can call and display content over a network and/or the Internet. A user can be a registered user to the system or be an anonymous user, i.e., the system does not have the user's identification information. Although the invention can present a generic arithmetic mean to everyone, only a registered user can have social circle mean rating generated and presented to him or her.

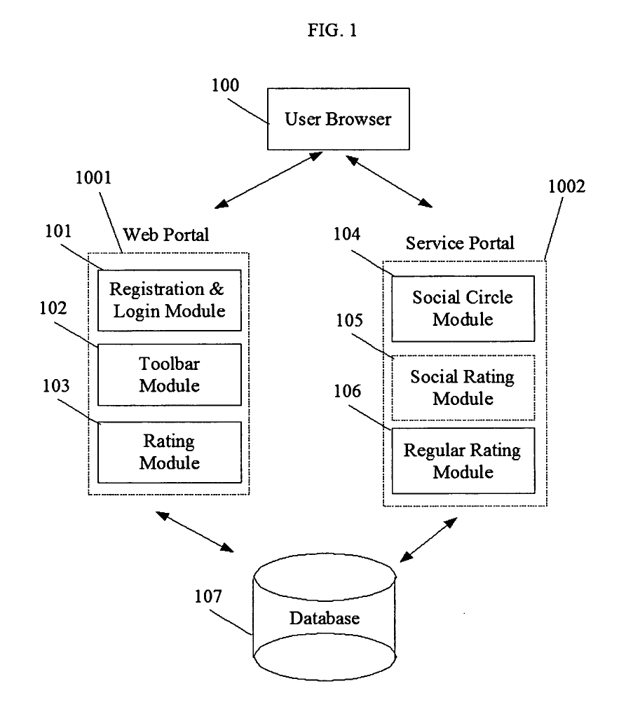

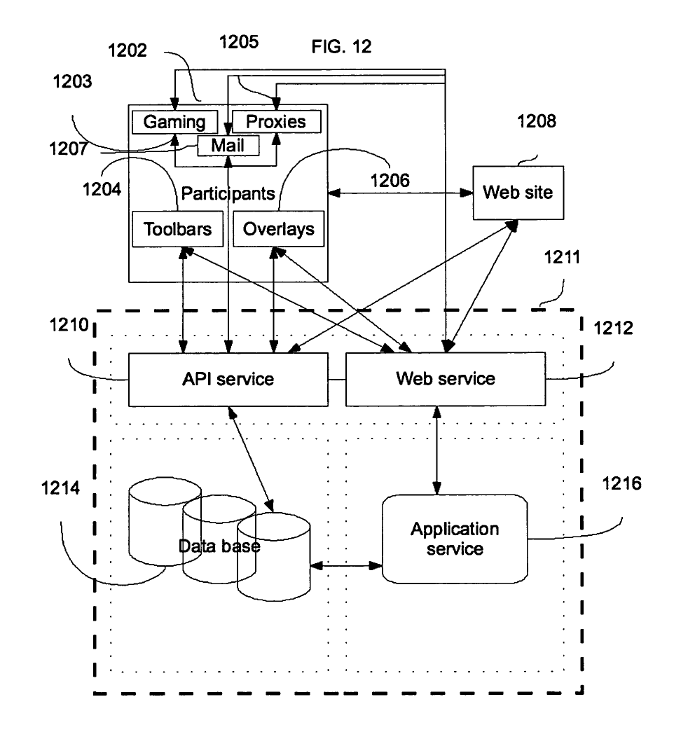

FIG. 1 shows the general architecture of a system that operates with one embodiment of the present invention. As shown in FIG. 1, a rating system can have two separate parts, a web portal part 1001 and a service portal part 1002. A higher level of description of a complete rating system embodied with the present invention is shown in FIG. 12. The web portal 1001 is represented in FIG. 12 as Web service part 1212 and application service part 1216. The service portal part 1002 is represented in FIG. 12 as API service part 1210. These two parts can be hosted in physically separate computer systems or co-hosted in one physical computer system but logically separated with different web servers.

The web portal part 1001 consist of three logical modules, a registration and login module 101, a toolbar download module 102 and a rating module 103. A database 107 is used to store all the information.

A user using a web browser 100 without a toolbar supported by this rating system will access web portal part 1001 of the system first. A user normally comes to the rating system's home page hosted in 1001 and the home page will contain links to the three sub-modules.

Module 101 is a registration and login module. A user who wants to register with the system or log into the system accesses this module. In registration mode, the module takes a user's input and stores the input in database 107. In login mode, the module checks a user's credential and if a user is registered user, a session state is established with the user through either cookies or another mechanism.

The toolbar module 102 provides a downloadable browser toolbar software to users. In certain embodiments such a download may be free of charge. A user (either registered or unregistered )can download and install the toolbar software in order to use services from 1002.

The rating module 103 provides functions for the web portal 1001 to process user rating submission, calculate generic mean ratings and present rating information back to users.

The service portal part 1002 primarily processes browser 100 toolbar rating request. It does not have a home page. It consists of three modules, a generic arithmetic rating module 104, a social circle calculation module 105 and a social circle mean rating module 106. The service portal 1002 needs to access the database 107 to obtain all necessary information. The database 107 is shared by the web portal 1001 and the service portal 1002.

The social circle module 104 calculates a user's social circle, or defines a group of users, dynamically, based on a user's online behavior. This could be determined from URI rating, URI tagging, URI visiting or some other online behavior.

The social rating module 105 uses a user's social circle information to calculate a user's social mean rating. Methods for determining and calculating a user's social mean rating are described below. Under preferred embodiments, a registered user can have social mean rating, but an unregistered user would not.

In preferred embodiments, the regular rating module 106 processes the generic arithmetic mean rating for a URL. It dynamically calculates a URL's mean rating whenever a new rating on a URL arrives.

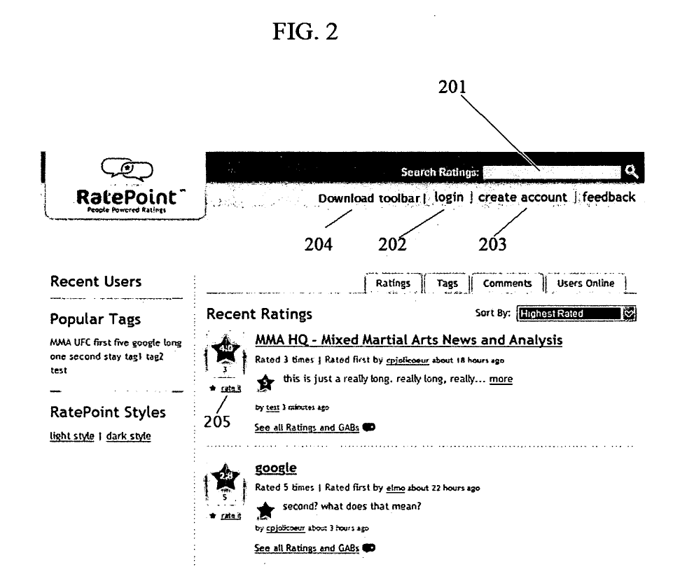

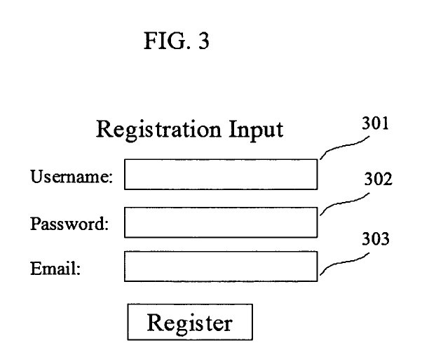

FIG. 2 shows a screen display of an exemplary home page for the web portal 1001. Users can access the three modules 101 102 and 103 from this page by clicking on their related links from the HTML page. The “create account” link 203 takes a user to registration module 102. An exemplary registration page is shown in FIG. 3 with a minimum set of information requested from users. A user who wants to download the toolbar software can follow the HTML link 204 to the module 102 to download the toolbar software. From 201 and 205, a user can access the rating module 103. A user can search a URI rating 201 or rate a URI 205 by submitting a rating to module 103.

FIG. 3 shows an exemplary registration page with a minimum set of information requested from users. In preferred embodiments, requested information includes username 301, password 302 and email 303, although alternate information could be requested in addition or instead.

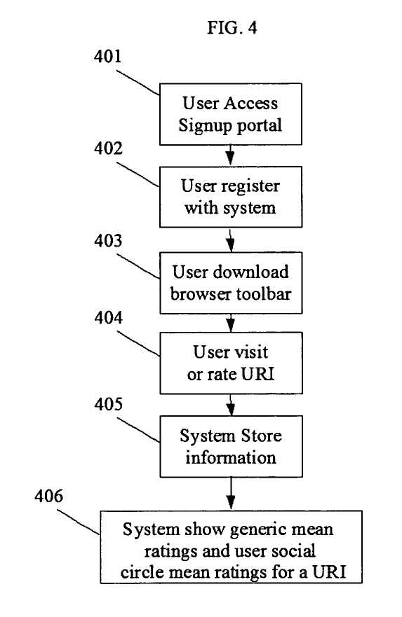

FIG. 4 is a block diagram showing a normal process flow when a user uses an exemplary system to get rating information on an URI and comes to the web portal part 1001 of the system. When a user accesses this system 1001 using a web browser, a web page FIG. 2 presents to the user with links to all three modules 101, 102, and 103.

If the user decides to register with the system by clicking the “create account” link 203, the system goes to the registration module 101 and displays a registration page such as FIG. 3 to the user 401. The registration module asks the user to enter some minimum required information 301 302 and 303 that will be used in the system to establish a unique user account. Once a user enters the minimum required information, a user record is created in the system database 107 with the user information and stored in a database table. A unique user id is established and used across the system 402. After a user is registered, the system offers the user to download the web browser toolbar software which the user can install in his or her web browser and take advantage of the toolbar functions 403. A user can download the toolbar software form the web portal 1001 home page FIG. 2 without registering with the system through 204. The toolbar download is completely optional. Without a browser toolbar, a user can still obtain URI rating services through the web portal rating module 1001. But the user has to manually enter the URI that he wants to obtain rating information from 201. If a user surfs the Internet using a web browser with a toolbar installed, whatever URI the user goes to with the browser, a URI rating request is automatically sent to 1002 by the toolbar 404. The URI rating information is instantly displayed in the web browser toolbar 406. The rating, tagging or visiting information of a user is stored in the system and used for user's social circle calculation 104.

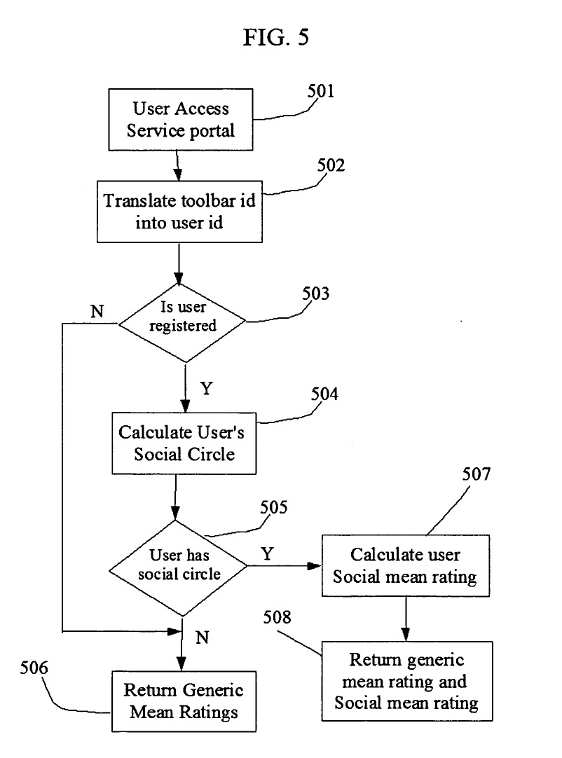

FIG. 5 shows a flow diagram of how a system embodied with this invention provides a user with a generic arithmetic rating or a generic arithmetic rating and a social circle mean rating. When a user with toolbar installed in his browser surfs the world-wide web, each URI the user visited is sent to the system's service portal 1002 for the URI rating. The request can be in several formats, an HTML request, an XML request or other format. An exemplary xml format request is as

```
<ratepoint>
  <toolbarid>{BA13A41-3F00-4c5d-5C025B}</toolbarid>
  <rating type=”URI”>
    <URI>http://www.ratepoint.com</URI>
  </rating>
</ratepoint>
```

When the service portal 1002 receives a request for a rating 501, it first translates the toolbar id into a user id 502. Each toolbar has a unique id to identify the toolbar. A toolbar id from a non-registered user could not translate into a user id. Under certain embodiments, only a registered user can have his/her toolbar id translated into his system user id. If a toolbar id could not be translated into a valid user id, the request is an anonymous request. Only a generic arithmetic rating is returned 506. No social circle mean rating is determined or provided.

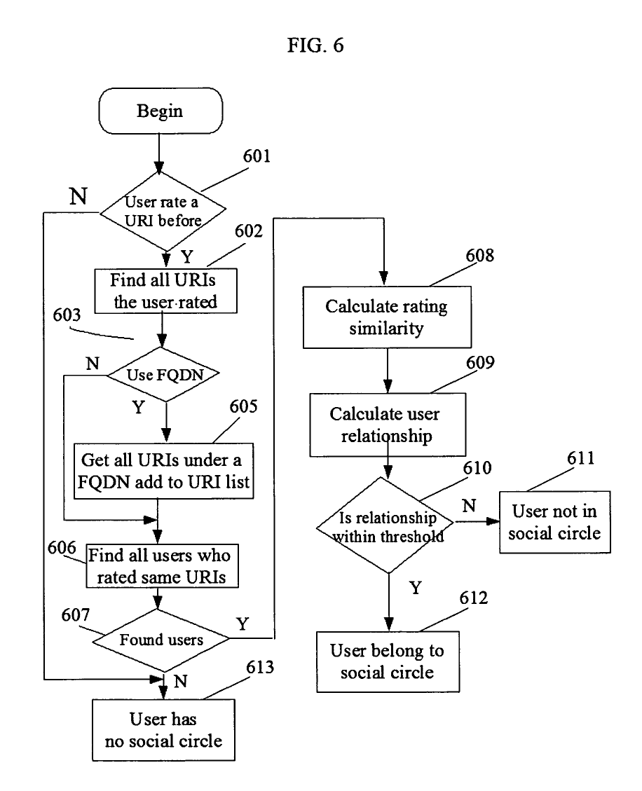

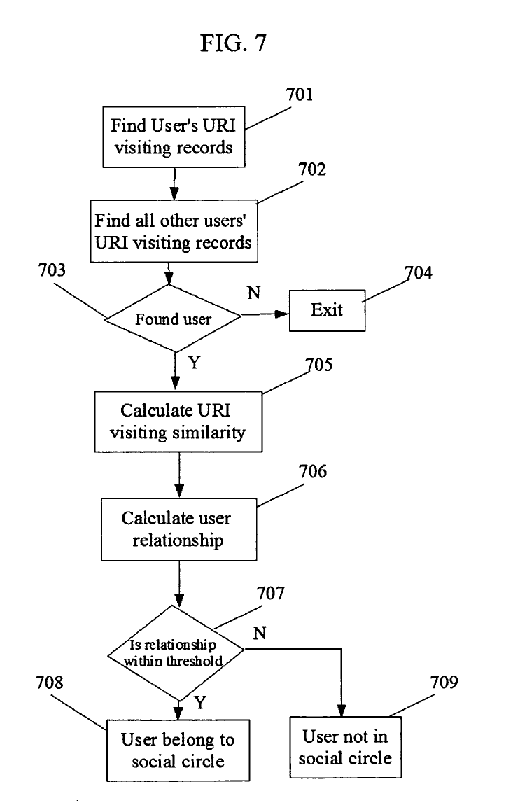

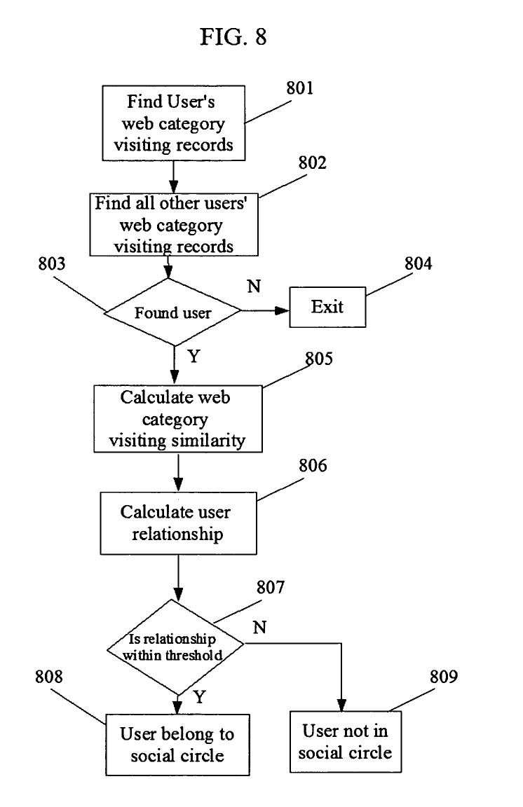

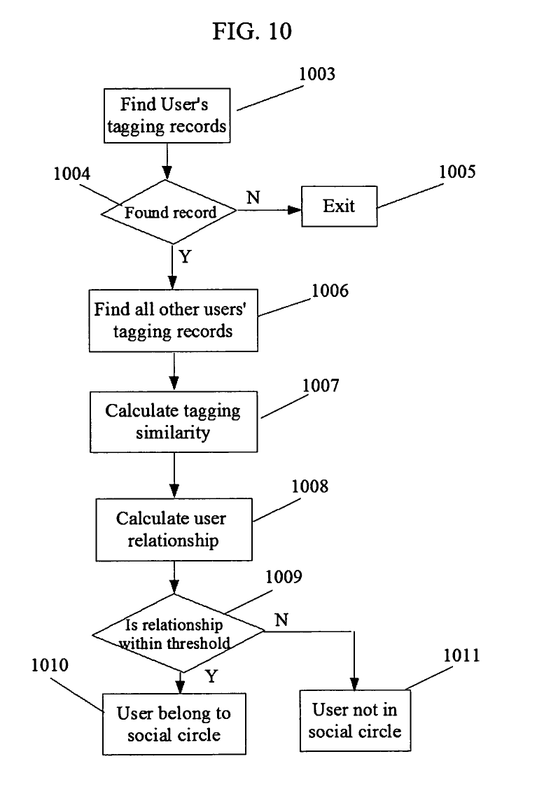

If a toolbar id is successfully translated into a user id, the user id is then used to locate the user's information such as rating, tagging, and visiting information. The rating, tagging and visiting information is then used to determine or calculate the user's social circle 504 using techniques described in conjunction with FIG. 6, FIG. 7, FIG. 8 and FIG. 10. If there is enough information in the system for the user to form a social circle using the above-mentioned technique, a social circle mean rating is determined for the requested URI 507. Then the generic arithmetic mean rating and the social circle mean rating are returned 508. Otherwise only the URI's generic arithmetic mean rating is returned 506.

The generic arithmetic mean rating for a URI is determined through the ratings of all users who rated this URI. The formula used is provided below:

GM=ΣRᵢ/N

Rᵢ is the rating value of ith user Vᵢ on the URI

N is the total number of users who has rated on the URI

A user's social circle mean rating for a URI is determined through the ratings of all users within the user's social circle, as described below. The formula used is provided below:

SM=ΣRₛ/N

Rₛ is the rating value of ith user Vᵢ among social circle on the URI

N is the total number of users in the social circle who has rated on the URI

An individual's social circle is broadly understood to mean a group of people who exhibit the same common behavioral activity as the individual. A group's behavioral activities are determined using one or more similarity techniques detailed below. Similarity can be understood as a “distance function” that measures the closeness of two numeric values. In certain embodiments, a numeric value could be created either consciously or subconsciously by a user and represent behavioral activities including but not limited to accessing a website, rating a URI, etc. Each such numeric value corresponds to a user-ratable object pair. Under certain embodiments, the user's social circle mean rating is a mean of rating values provided by users within the user's particular social circle.

FIG. 6 shows the flow diagram of how a user's social circle is determined based upon the user's URI rating information in the system. When the system receives a request from a user, the system uses the user's id to check its database to see whether the user has rated any URI 601. This could be done with a database query using the unique user id. If the system cannot find any rating record by this user, the rating based social circle calculation terminates 613. If the system does find some rating records by the user, a rating record based social circle determination will start. The rating record based social circle is determined as follows:

If a user U has rated a URI before, find all the URIs the user has rated 602 through database query using user's unique id. The URI will form a user rated URI list.

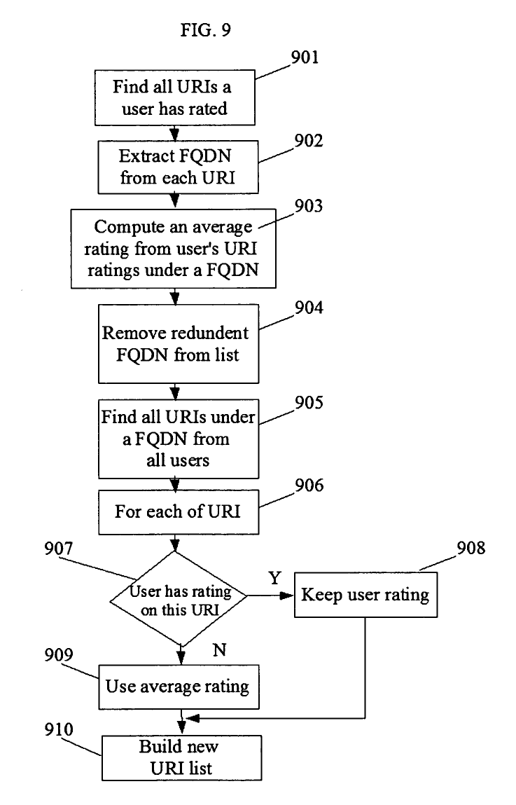

If the system is allowed to use fully qualified domain name (FQDN) as a calculation unit 603, get all the URIs under a FQDN (a FQDN is extracted from the URI from the URI list built in last step) 605 and add the URI to the URI list obtained in 602. The detailed process for getting all the URIs is described FIG. 9.

For each URI the user has rated, find all other users who have rated on the same URI. Build a user/url matrix which contains the ratings of each user on the URIs obtained in step 1 and 2 606.

If the system could not find any user who has rated on at least one common URI with the user U, the user U does not have social circle at this moment. The process terminates 613.

If the system finds users who have rated on at least one URI that the user U also rated. Then a rating similarity for a URI between the user U and all other users V who has rated this URI is calculated 608. Minimum and Maximum parameters can be established. A user must rate at least a minimum number of URIs to be considered to have social circle. Also, if a user has rated a very large number of URIs, and the number exceeds the maximum number set up in the system. Only the maximum number of URIs will be used in the social circle calculation. The calculation technique is as this:

For each user Vi who has rated at least one URI which the user U also rated, calculate a rating similarity. The rating similarity for a single URI j between the user U and ith user Vi is determined by:

Sₛᵢⱼ=M−|Vₛⱼ−Vᵢⱼ|

Sₛᵢⱼ is the similarity between user U and ith user Vᵢ on jₜₕ URI

Vₛⱼ is the user U's rating value on jₜₕ URI

Vᵢⱼ is the ith user Vᵢ's rating value on jₜₕ URI

M is the maximum rating value that can be used in the system

Once the rating similarity is calculated for each URI in 608, a relationship value of the user U with the ith user Vi is calculated in 609. The relationship value is calculated using the following formula:

RₛᵢΣSₛᵢⱼ/N

Rₛᵢ is the relationship between the user U and ith user Vᵢ

Sₛᵢⱼ is the similarity on ith URI between the user U and ith user Vᵢ

N is the number of URIs rated by both the user U and the ith user Vᵢ

A conditional threshold Tu can be used to require that a minimum number of URIs have to be matched between the user U and a user Vi in rating record. If the N is less than the threshold Tu, the relationship is 0.

When relationship values for a user U and all other user Vi are calculated, a decision can be made to decide whether a user Vi belongs to user U's social circle 610. A relationship threshold Tr (Tr is between 1 and M, the maximum rating number used in the system) is used. The calculation is as below:

For every user Vᵢ who has a relationship with the user U

if the relationship Rₛᵢ is greater than the threshold Tᵣ

Rₛᵢ>=Tᵣ

then the iₜₕ user Vᵢ is defined as belonging to the user U's social circle.
Vᵢ in U's social circle

Otherwise
Vᵢ not in U's social circle

FIG. 7 shows the flow diagram of how a user's URI visiting record is used to calculate a user's social circle. A user's URI visiting record is used to calculate a user's social circle when the system could not find a social circle for a user based on the user's rating record. It is an optional operation to use. It can be switched on or off through a system flag. It is most useful in an early stage of a new system to use a user's URI visiting record to calculate a user's social circle. Once a system is in operation for a period of time and many users have established rating record with the system, the URI visiting record based social circle calculation can be phased out in the system.

When a system embodied with this invention receives a request from a user, the system first tries to use the user's rating record to find the user's social circle. If the rating record based method or other method could not find any user to form a social circle, then the user's URI visiting record based social circle calculation will come into play if the system is set up to use it

The URI visiting record based social circle is determined as follows:

If a user U has URI visiting record in the system, find all the URI the user has visited using the user id through database query 701. Build a user visited URI list with the database query result.

For each URI from the list build in above step, find all other users who have also visited the same URI through database query. Build a user/url matrix which contains the number of visit for each user on all the URIs obtained in 702.

If the system could not find any user who has visited the same URI as the user U, the user U does not have a social circle at this moment. The process terminates 704.

If the system finds users who visited at least one common URI as the user U, then a similarity for a URI between the user U and all other users V is calculated 705. Minimum and Maximum parameters can be established in the calculation. A user must visit a URI at least the minimum amount of times in order to make this URI eligible to be used in a social circle calculation. Also, if a user visited a URI a very large number of times and the number exceeds the maximum number the system requires, only the maximum number of visit will be used. The calculation technique is as follows.

For each user Vi who has visited the same URI which the user U also visited, calculate a visiting similarity. The visiting similarity for a single URI j between the user U and ith user Vi is determined by:

Sₛᵢⱼ=(M−|Vₛⱼ−Vᵢⱼ|)/M

Sₛᵢⱼ is a similarity between user U and ith user Vᵢ on jₜₕ URI

Vₛⱼ is the user U's number of visits on jₜₕ URI.

Vᵢⱼ is the ith user Vᵢ's number of visits on jₜₕ URI

M is the larger number of Vₛⱼ, and Vᵢⱼ.

Once the similarity is calculated for each URI, a relationship value of the user U with the ith user Vi is calculated 706. The relationship value is calculated using the following formula:

Rₛᵢ=ΣSₛᵢⱼ/N

Rₛᵢ is the relationship between the user U and iₜₕ user Vᵢ

Sₛᵢⱼ is the similarity on jₜₕ URI between user U and iₜₕ user Vᵢ

N is the number of URIs both visited by the user U and the iₜₕ user Vᵢ

Calculate the relationship between the user U and all other users using the above formula.

When the relationship values for a user U and all other user Vi are calculated, a decision can be made to decide whether a user Vi belongs to user U's social circle 707. A relationship threshold Tr (Tr is between 0 and 1) is used. The calculation is as below:

For every user Vᵢ who has a relationship with the user U

if the relationship Rₛᵢ is great than the threshold Tᵣ

Rₛᵢ>=Tᵣ

then the iₜₕ user Vᵢ is defined as belonging to the user U's social circle.
Vᵢ in U's social circle

Otherwise
Vᵢ not in U's social circle

FIG. 8 shows the flow diagram of how a user's web category visiting record is used to calculate a user's social circle. A user's web category visiting record is used to calculate a use's social circle when the system could not find a social circle for a user based on the user's rating record. It is an optional module. It can be switched on or off through a system flag. It is most useful in an early stage of a new system to use a user's URI visiting record to calculate a user's social circle. Once a system is in operation for a period of time and many users have established rating record with the system, the web category visiting record based social circle calculation can be phased out in the system.

The web category visiting record based social circle is determined as follows:

If a user U has web category visiting record in the system, find all the web categories the user has visited using the user id through database query 801. Build a user visited URI list with the database query result.

For each web category the user has visited, find all other users who have also visited the same web category through database query. Build a user/url matrix which contains the number of web category visit for each user on all the URIs obtained in 802.

If the system could not find any user who has visited the same web categories as the user U, the user U does not have a social circle based on the web category visiting record at this moment. The process terminates 804.

If the system finds users who have visited at least one web category which the user U also visited, then a similarity for a web category between the user U and all other users V is calculated 805. Minimum and Maximum parameters can be established in the calculation. A user must visit a web category at least the minimum amount of times in order to make this web category eligible to be used in a social circle calculation. Also, if a user visited a web category a very large number of times and the number exceeds the maximum number the system requires, only the maximum number of visit will be used. The calculation technique is as follows.

For each user Vi who has visited the same web category which the user U also visited, calculate a visiting similarity. The visiting similarity for a single web category j between the user U and ith user Vi is defined as:

Sₛᵢⱼ=(M−|Vₛⱼ−Vᵢⱼ|)/M

Sₛᵢⱼ is a similarity between user U and ith user Vᵢ on jₜₕ web category

Vₛⱼ is the user U's number of visits on jₜₕ web category.

Vᵢⱼ is the ith user Vᵢ's number of visits on jₜₕ web category

M is the maximum number between Vₛⱼ, and Vᵢⱼ.

Once the visiting similarity is calculated for each web category, a relationship value of the user U with the ith user Vi is calculated 806. The relationship value is calculated using the following formula:

Rₛᵢ=ΣSₛᵢⱼ/N

Rₛᵢ is the relationship between the user U and Iₜₕ user Vᵢ

Sₛᵢⱼ is the similarity on jₜₕ web category between user U and iₜₕ user Vᵢ

N is the total number of web categories the system used to classify URIs.

Calculate the relationship between the user U and all other users using the above formula.

When the relationship values for a user U and all other user Vi who visited the same web categories as the user U are obtained, a decision can be made to decide whether a user Vi belongs to user U's social circle 807. A relationship threshold Tr (Tr is between 0 and 1) is used. The calculation is as below:

For every user Vᵢ who has a relationship with the user U if the relationship Rₛᵢ is greater than the threshold Tᵣ

Rₛᵢ>=Tᵣ

then the ith user Vᵢ is defined as belonging to the user U's social circle.
Vᵢ in U's social circle

Otherwise
Vᵢ not in U's social circle

FIG. 9 shows the process flow to use a fully qualified domain name (FQDN) as a unit to calculate a user's social circle. When a few URIs have been rated by more than one user, using URI as a unit to find a user's social circle would have little success. To use a larger unit such as FQDN instead of URI would have better result. In an exemplary embodiment, the implementation is to include all URIs in the system under a FQDN in the calculation of a user's social circle. The calculation unit is still URI and not FQDN. But since all URIs under a FQDN are included. It is equivalent to using a FQDN as a calculation unit. To do this, The first step is to find all the URIs the user has rated using the user's id through a database query. The database query result is a URI list 901.

Then for each URI on the list, the FQDN is extracted from the URI 902. Then an average rating is computed from all the URIs under each FQDN rated by the user 903. A FQDN list is build from the URI list. All the redundant FQDNs are removed from the FQDN list 904. Using this non-duplicated FQDN list, for each FQDN, retrieves all URIs rated by all users from the system database 107 in step 905. The resulting URIs include the current user rated ones and all other users rated ones 906.

A test is made in step 907 to see if the current user has a rating for a URI obtained from database under a FQND. If the user has rated the URI, the user's rating is kept for the URI 908. If a URI has not been rated by the user, the average rating calculated in 903 will be used to fill the rating for this URI under the user 909.

When all the URIs obtained from the non-duplicate FQDN list have been checked, a new expanded URI list is formed 910. This new list includes all URIs with ratings under each FQDN obtained from 902 and makes it equivalent to using FQDN as a unit to calculate a user's social circle. This new URI list replaces the old URI list obtained in 901 which only includes the current user rated URIs. With this new URI list, then the system continue to the social circle process 606.

FIG. 10 shows the flow diagram of how a user's tagging records are used to calculate a user's social circle. Tags are generally understood to mean a list of user specified key words attached to an entity that further describe the entity. A user's tagging record is used to calculate a user's social circle. When a tagging based social circle is enabled, this module will be used.

The tagging record based social circle is determined as follows. If a user U has tagging records in the system, find all the user's tags in the system 1003. If the user has no tag in the system, the process terminates 1005. The system then finds all other users who have tags in the system 1006. Build a user list. If the system find other users who have tags in the system. Then a similarity between the user U and each other users Vi is calculated 1007. Minimum and Maximum parameters can be established in the calculation. A user must have a minimum amount of tags in order to be considered in tagging based social circle calculation. If a user has a very large amount of tags that exceeds the maximum number of tags the system requires for computing a social circle, only the maximum number is used. The similarity calculation technique is as follows.

For each user who has tags in the system, calculate a tagging similarity. The tagging similarity between the user U and ith user Vi is defined as:

Sₛᵢ=Vₙₜ

Sₛᵢ is a similarity value between user U and ith user Vᵢ

Vₙₜ is the number of overlapping tags user U and ith user Vᵢ both have. (Since a tag is an word, the overlapping tags mean the words are the same.)

If Vₙₜ is below a minimum threshold Tₘᵢₙ, Sₛᵢ is 0.

If Vₙₜ is above a maximum threshold Tₘₐₓ, Sₛᵢ is set to the maximum threshold number Tₘₐₓ.

Once the tagging similarity is calculated, a relationship value of the user U with the ith user Vi is calculated 1008. The relationship value is calculated using the following formula:

Rₛᵢ=Sₛᵢ

Rₛᵢ is the relationship between the user U and iₜₕ user Vᵢ

Sₛᵢ is the similarity value between user U and iₜₕ user Vᵢ

Calculate the relationship between the user U and all other users using the above formula.

When the relationship values for a user U and all other user Vi are calculated, a decision can be made to decide whether a user Vi belongs to user U's social circle 1009. A relationship threshold Tr (1 to Tmax) is used. The calculation is as below:

For every user Vᵢ who has a relationship with the user U

if the relationship Rₛᵢ is greater than the threshold Tᵣ

Rₛᵢ>=Tᵣ

then the iₜₕ user Vᵢ is defined as belonging to the user U's social circle.
Vᵢ in U's social circle

Otherwise
Vᵢ not in U's social circle

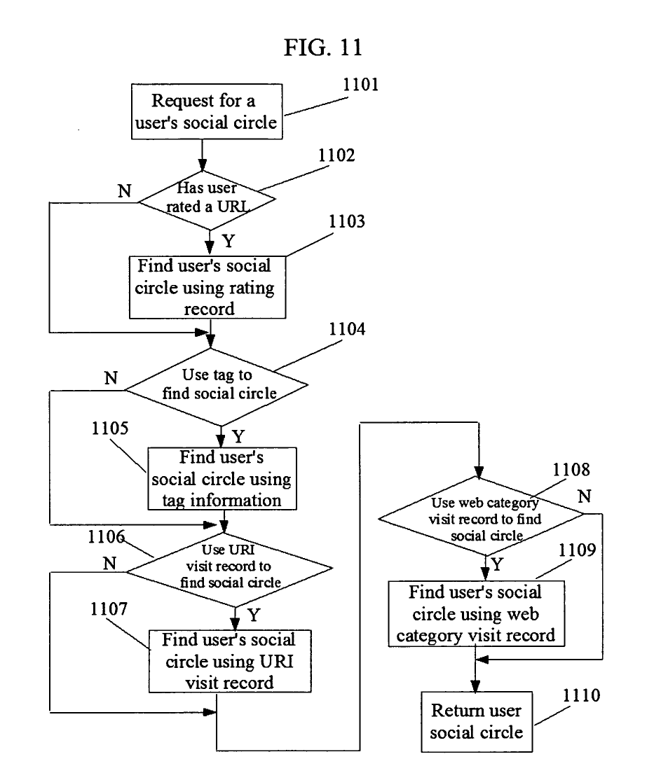

FIG. 11 shows the flow diagram of how a system utilize a user's rating records, tagging records, URI and web category visiting records to calculate a user's social circle. When the system receives a request to calculate a user's social circle 1101, the service portal 1002 first checks the database to determine whether the user has rated any URI in the past 1102 using the user's id. If the user has rating records in the system, the user rating record based social circle calculation is used to obtain the user's social circle 1103. The user rating record based social circle calculation is described in detail in FIG. 6 and FIG. 9. It includes using URI and FQDN as basic unit to obtain user social circle.

After a rating based social circle calculation, the system checks whether a user's tagging information based social circle calculation is enabled 1104. If it is enabled, then the system uses the user's tagging record based social circle calculation technique and process flow described in FIG. 10 to calculate the user's social circle 1105.

After the tagging based social circle calculation, the system checks to see whether a URI visiting record based social circle calculation is enabled 1106. If a URI visiting record based social circle calculation is enabled, the system uses the URI visiting record based social circle calculation technique and process flow described in FIG. 7 to obtain the user's social circle 1107.

When URI based social circle calculation completes, the system checks to see the web category visiting record based social circle calculation is enabled or not. If it is enabled, the web category visiting record based social circle calculation technique and process flow described in FIG. 8 is used to obtain user's social circle. The final social circle is the combination of social circle calculated in each step described above.

Since a user's social circle can be obtained through five different techniques, effectively, there are at least five different types of social circles. The types of social circles include: URI rating based, FQDN rating based, tag based, URI visit record based and web category visit record based. There are subtle distinctions among the different types of social circles. Based on actual applications needs, any combination of the social circle can be used. A system has a capability to switch on or off FQDN rating based module, tagging based module, URI visiting record based module and web category visiting record based module. The exemplary system uses system controlled switching to turn on or off a social circle calculation module. However, this invention can also employ a user controlled switch which enables the user to control which module can be used to generate and calculate his/her social circle.

The exemplary system implements this invention also lists a user's social circle in a ranked order. The one with the highest relationship number in a user's social list is placed first. When an application receives a social circle list, it can present the social circle in a meaningful way. The social circle can also presented with other data such as URI tagging information besides for calculating a social circle mean rating.

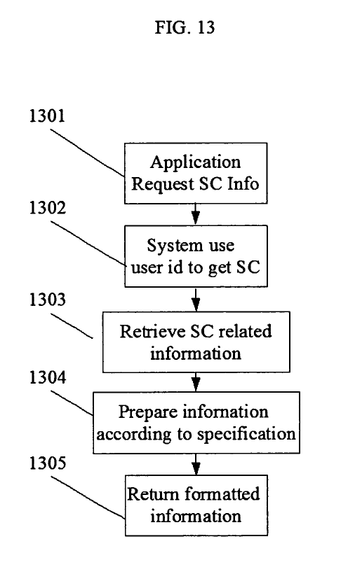

FIG. 13 shows an example of a process flow used in the Service Portal 1002 to obtain information specific social circle information. When a user or an application submits a request to service portal 1002, the system performs step 1302 and uses the requested user ID to retrieve the social circle of the requested user. If, in step 1302 it is determined by the system 1002 that a social circle exists for the requested user, the system 1002 can use the social circle and retrieve information related to each user and contained within the requested user's social circle such as, tag information, URI information, FQDN information, second level domain name (SLDN) information, and any subset of URI information, and/or other information contained within the system 1002 and related to each user which is able to be presented in a refined way through a social circle as outlined in step 1303. This information can be further processed as described in step 1304. For example, if a request asks for tag information related to a requested user's social circle, the system 1002 retrieves all tag information from users within the requested user's social circle. Following, the tag information retrieved can be analyzed for usage frequency and presented as requested. For example, the information could be displayed in an ordered tag list with the frequency as described in step 1305. In addition, this information could be displayed in another ordered or sorted method.

Additionally, if a request asks for URI, FQDN or SLDN information related to a user's social circle, the system 1002 retrieves all URI, FQDN or SLDN information from users within the requested user's social circle. Then the URIs, FQDNs, or SLDNS can be analyzed and presented as requested. For example, in an ordered URI list with the highest visited URI in first and lowest visited URI at last. In addition, this information could be displayed in another ordered or sorted method.

Also, if a request asks for any other kind of information related to a user's social circle, the system 1002 retrieves all the specified information from users within the requested user's social circle. Then the specified information can be analyzed and presented as any requested format. As described, all information that is known to the system 1002 and is related to a user's social circle can be used to generate subsequent reports and layout model, allowing the information within a social circle to be represented in many ways. Whenever an entity is labeled with a numeric value, the numeric value can be any thing as a rating, a visiting number, or some description values, this invention can be applied to obtain a similarity value and relationship value using the methods and formulas described in FIG. 6, FIG. 7, FIG. 8 and FIG. 10. The similarity value and relationship value then can be used to form a special group. Refined data mining can also be performed with the refined group.

For example, the methods described above can be used on products (electronics, books, music, movies), services (web services, utility services), ratings (users rates other raters for both quantitative ratings (e.g. 5 stars) and qualitative ratings (e.g. free formed comments). This information could be used in calculating more refined social circles and lead to new insights of a user's likes and dislikes. For example, users free-formed comments can be analyzed for style such that we match users to each other and extended or narrowing their social circle. Additionally, the system can provide new services that deliver new suggestion service to the users. After calculating a user's social circle an analysis of all the product ratings within the user's social circle could be generated that provides a rank order of potential products that a user might like. This can be further filtered by product type (e.g. cameras). In this instance, the refined rating would yield the best camera for the user and not the best selling camera. Similar data could be delivered for other data types. The same analysis could be delivered for services, such that the system will recommend the best services for the user based on the services that have been rated in the social circle.

While a preferred embodiment of the present invention in an exemplary system has been described above for rating URIs, it should be considered that it is only provided as an example and the method can be applied to a company, a product, a web site, web page content, a virtual object, virtual products, or virtual service.

While the above description refers to preferred embodiments of a system and method for determining behavioral similarity between users and user data to identify groups to share user impressions of ratable objects, other embodiments are possible. For example other statistical measures may be used in place of the arithmetic means described above. Additionally, while preferred embodiments include target objects such as a company, a product, a URI, a web site, web page content, a virtual object, virtual products, or virtual service (ex. virtual objects, product and services are found inside a gaming environment and other virtual worlds), any range of target objects could be rated. Such target objects may be referred to as ratable entities. In many cases the particular applications supporting the web pages in question are source of limitation in which target objects can be selected for rating. In preferred embodiments the system automatically monitors usage activity of a user and that information is analyzed to produce a profile that describes in computerized form the usage of the user. Those profiles are subsequently analyzed to compare usage among users. The usage analysis profile of the user includes web-visiting records, tagging records, rating records and using a fully qualified domain name or other usage information monitored by the system.

The present invention in its various embodiments utilizes a range of computer and computer system technologies widely known in the art, including memory storage technologies, central processing units, input/output methods, bus control circuitry and other portions of computer architecture. Additionally, a broad range of internet technologies well-known in the art are used.

It will be further appreciated that the scope of the present invention is not limited to the above-described embodiments but rather is defined by the appended claims, and that these claims will encompass modifications and improvements to what has been described.

What is claimed is:

1. A method of rating computerized entities within a network, comprising:
identifying a plurality of users of the network;
automatically monitoring usage activities of the plurality of users to compile and record information about the usage of ratable computerized entities within the network by each user;
analyzing the compiled information to determine similarity among users and to define social groups of users in which each member of a social group has a similar usage analysis profile of ratable computerized entities to other members of the group;
receiving and recording rating information from the users about the computerized ratable entities;
for each social group, determining an aggregate rating for each ratable computerize entity as a function of the rating information received from each member of each group;
presenting on a display the aggregate rating information for a ratable computerized entity for a social group to a user who is a member of the social group.

2. The method of claim 1, wherein similarity among users is determined by a distance function.

3. The method of claim 1, wherein analyzing the compiled information to determine similarity among users is further determined by the usage analysis profile of the user.

4. The method of claim 1, wherein analyzing the compiled information to determine similarity among users is determined by the rating provided by the user of the ratable computerized entity.

5. The method of claim 2, wherein a distance function computes the closeness of the usage analysis profile of a first user relative to the usage analysis profile of another user.

6. The method of claim 3, the usage analysis profile of the user includes web-visiting records.

7. The method of claim 3, the usage analysis profile of the user includes tagging records.

8. The method of claim 3, the usage analysis profile of the user includes URI rating records.

9. The method of claim 3, the usage analysis profile of the user includes using a fully qualified domain name.

10. The method of claim 1, wherein automatically monitoring usage activities of the plurality of users further includes using a server system web portal.
